(19) United States
(12) Patent Application Publication
(10) Pub. No.: US 2017/0137053 A1
(43) Pub. Date: May 18, 2017

(54) TRANSMISSION DEVICE AND RACK CORNER STEERING MECHANISM THEREOF

(71) Applicant: SHENZHEN ZHAOWEI MACHINERY&ELECTRONICS CO.,LTD., Shenzhen (CN)

(72) Inventors: Jiayi FEI, Shenzhen (CN); Dong XIN, Shenzhen (CN); Fenyong NAN, Shenzhen (CN)

(73) Assignee: SHENZHEN ZHAOWEI MACHINERY&ELECTRONICS CO.,LTD., Shenzhen (CN)

(21) Appl. No.: 15/035,984

(22) PCT Filed: Oct. 20, 2015
(86) PCT No.: PCT/CN2015/092309

§ 371 Date: May 11, 2016

(51) Int. Cl. B62D 3/12; F16H 55/26; F16H 19/04

(52) U.S. Cl. CPC B62D 3/126; F16H 19/04; F16H 55/26

(57) ABSTRACT

A transmission device and a rack corner steering mechanism, the rack corner steering mechanism comprises an input gear (10) and a rack steering assembly (20), the rack steering assembly (20) comprises a plunger (21) and a plurality of rack units (22), the plunger (21) is a straight bar and is moved along a straight trajectory, and the plunger (21) adjacent to the rack unit (22) is obliquely connected to an end of the plunger (21), each of the other rack units (22) is successively connected to the end of the front rack unit (22), when each rack unit (22) is engaged with the input gear (10), the rack unit (22) is rotated and is in line with the plunger (21). The rack unit (22) can be rotated to ensure the flexible steering of the steering mechanism, the reciprocating motion of the input gear (10) is converted into the reciprocating motion of the plunger (21), which has the advantages of smooth operation, good continuity, low noise, high bearing capacity, reliable, compact structure, and small volume.

The invention belongs to the technical field of transmission, in particular to a transmission device and a rack corner steering mechanism thereof

### BACKGROUND

In the transmission mechanism, the pinion-and-rack transmission mechanism is mainly used for converting rotary motion of the gear into linear motion of the rack, and the rack as a whole, usually only reciprocates along a straight line.

To realize the rack steering and continuous motion and power transfer, generally an arc track is arranged at the corner to achieve steering the rack in the arc track. However the transmission mechanism of the arc track has poor stability, tends to jam, and has significant friction between the rack and the arc track and low transmission efficiency.

### SUMMARY

The present invention aims at providing a transmission device and a rack corner steering mechanism thereof, to solve the existing problem that the rack corner steering has poor stability, tends to jam, and has low transmission efficiency.

To solve the above technical problem, the preset invention provides a rack corner steering mechanism comprising an input gear and a rack steering assembly driven by the input gear, wherein the rack steering assembly comprises a plunger and a plurality of rack units which are successively movably connected to an end of the plunger and arranged in a corner shape, wherein the plunger is a straight bar and is moved along a straight trajectory, a side wall of the plunger close to the input gear is a first tooth surface to be engage with the input gear, the side walls of each of the rack units close to the input gear is a second tooth surface to be engage with the input gear, the rack unit adjacent to the plunger is obliquely connected to the end of the plunger, each of the other rack units is successively connected to the end of the front rack unit, and when the second tooth surface of the rack unit is engage with the input gear, the rack unit is rotated and is in line with the plunger.

Optionally, each of the rack unit comprises a main body, the front side of the main body is provided with a connecting part, the rear side of the main body is caved inward to form a first connecting groove, the end of the plunger is provided with a second connecting groove, the connecting part of the rack unit adjacent to the plunger extends in the second connecting groove and is pivotally connected through a connecting column, the connecting part of each of the other rack unit successively extend in the first connecting groove of the front rack unit and is pivotally connected through the connecting column.

Optionally, each connecting part is a connecting block integrally formed on the main body, the side walls of the main body close to the input gear is the second tooth surface, the side wall of the connecting block close to the input gear flushes with the second tooth surface, the second tooth surface extends to the side wall of the connecting block close to the input gear, and the connecting column is parallel to the second tooth surface.

Optionally, each connecting column is disposed on an arc trajectory of the corner.

Optionally, the rear wall of each main body is provided with a first inclined surface at the position connected with the second tooth surface.

Optionally, in the first connecting groove, an inner wall opposite to a insertion direction of the connecting part is provided with a second inclined surface at the position connected with the second tooth surface; within the second connecting groove, the inner wall opposite to the insertion direction of the connecting part is provided with a third inclined surface at the position connected with the first tooth surface.

Optionally, the rack corner steering mechanism further comprises a housing, a cylinder and a retainer, the housing has the corner, the cylinder is arranged at the front side of the corner, the plunger is inserted into the cylinder, each rack unit is located at the corner, the input gear is fixed on the retainer.

Optionally, the retainer comprises a nozzle portion with a C-shaped cross-section and fixing portions extending upward from two ends of the nozzle portion, the nozzle portion is connected to the cylinder to allow the plunger and each rack unit to pass through, the input gear is fixed between two fixing portions.

Optionally, the bottom of the nozzle portion is provided with needle rollers.

The present invention also provides a transmission device comprising the rack corner steering mechanism mentioned above.

In the present invention, the rack corner steering mechanism uses the rack unit in a horizontal position to drive other rack units, and the rack unit can be rotated to ensure the flexible steering of the steering mechanism, the reciprocating motion of the input gear is converted into the reciprocating motion of the plunger, which has the advantages of smooth operation, good continuity, low noise, high bearing capacity, reliable, compact structure, and small volume.

### BRIEF DESCRIPTION OF THE DRAWINGS

FIG. 1 shows a schematic structure view of the rack corner steering mechanism of the embodiment of the present invention;

FIG. 2 shows the schematic structure view of the rack steering assembly of the embodiment of the present invention;

FIG. 3 shows the schematic structure view of the rack unit of the embodiment of the present invention;

FIG. 4 shows the top view of the rack unit of the embodiment of the present invention;

FIG. 5 shows an enlarged view of A part in FIG. 2;

FIG. 6 shows a schematic view of the assembled rack steering assembly and the cylinder of the embodiment of the present invention;

FIG. 7 shows the schematic structure view of the rack corner steering mechanism before steering of the embodiment of the present invention;

FIG. 8 shows the schematic structure view of the rack corner steering mechanism after steering of the embodiment of the present invention;

FIG. 9 shows the motion track of the rack steering assembly of the embodiment of the present invention;

10—input gear; 20—rack steering assembly 21—plunder;

211—first tooth surface; 212—second connecting groove; 22—rack unit;

221—second tooth surface; 222—main body; 223—connecting part;

224—first connecting groove; 225—first connecting hole; 226—second connecting hole;

227—first inclined surface; 228—second inclined surface; 30—housing;

40—cylinder; 50—retainer; 51—nozzle portion;

52—fixing portion; 60—needle roller.

### DESCRIPTION OF EMBODIMENTS

To make the objectives, technical solutions, and advantages of the present invention clearer and more comprehensible, the following further describes the present invention in detail with reference to the accompanying drawings and embodiments. It should be understood that the specific embodiment described herein is merely used to explain the present invention but is not used to limit the present invention.

It should be noted that when an element is described as “fixed on” or “disposed on” another element, it can be directly on another element or there may be an intermediate element between them; when an element is described as “connected to”, it can be directly connected to another element or there may be an intermediate element between them.

It also should be noted that the orientation terms in the embodiments such as left, right, top, bottom and so on, are only relative concepts or are referenced to the normal operating state of the product, and should not be considered to be restrictive.

The following specific examples of the specific implementation of the invention are described in detail:

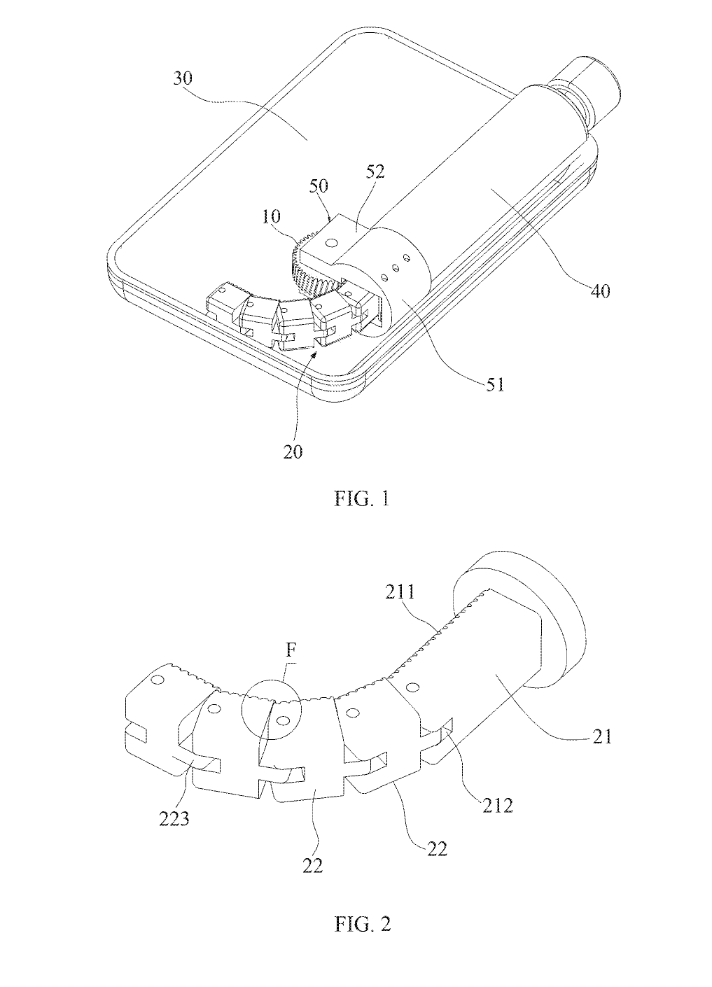

Referring to FIG. 1, FIG. 2, the present invention provides a corner rack steering mechanism comprises an input gear 10 and a rack steering assembly 20 driven by the input gear 10. The rack steering assembly 20 comprises a plunger 21 and a plurality of rack units 22 successively movably connected to an end of the plunger and arranged in a corner shape. The input gear 10 is located on one side of the rack steering assembly 20, the plunger 21 is a straight bar and along a linear trajectory, a side wall of the plunger 21 close to the input gear 10 is a first tooth surface 211, the side wall of each rack unit 22 close to the input gear 10 is a second tooth surface 221, the teeth on the first tooth surface 211 is the same as the teeth on the second tooth surface 221, the teeth can be engaged with the input gear 10. The plunger 21 adjacent to the rack unit 22 is obliquely connected to the end of the plunger 21, each of the other rack units 22 is successively obliquely connected to the end of the front rack unit 22. Since the plunger 21 is a straight bar and is moved along a straight trajectory, when the motion of the plunger 21 drives the respective rack units 22 to move forward and when the second tooth surface 221 of each rack unit 22 is engaged with the input gear 10, the engaged rack unit 22 is rotated a certain angle and is in line with the plug 21.

In the present invention, the plunger 21 is used to drive the rack unit 22 in a horizontal position adjacent thereto, and this rack unit 22 is used to drive the other rack units 22 at the corner, during the process the rotatable structure of the rack units 22 ensure the flexible steering of the steering mechanism, the reciprocating motion of the input gear 10 is converted into the reciprocating motion of the plunger 21, which has the advantages of smooth operation, good continuity, low noise, high bearing capacity, reliable, compact structure, and small volume.

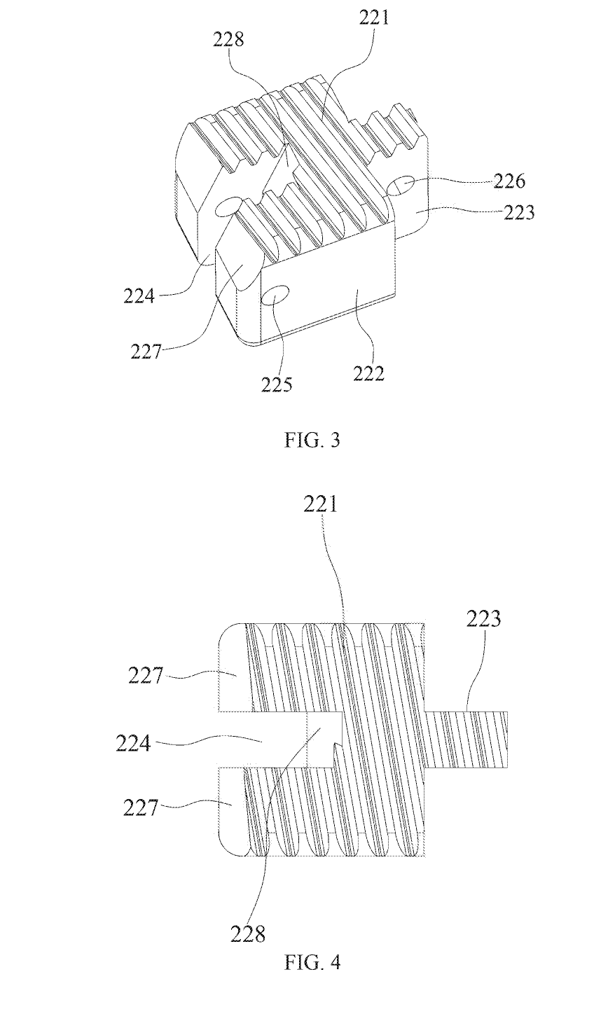

Also referring to FIGS. 3 and 4, in this embodiment, each rack unit 22 has the same configuration. The rack unit 22 comprises a main body 222, the front side of the body 222 is provided with the connecting part 223, the rear side of the main body 222 is caved inward to form a first connecting groove 224. The end of the plunger 21 is provided with a second connecting groove 212, the connecting part 223 of the rack unit 22 adjacent to the plunger 21 extends in the second connecting groove 212 and is pivotally connected through a connecting column (not shown), the connecting part 223 of each of the other rack unit 22 successively extend in the first connecting groove 224 of the front rack unit 22 and is pivotally connected through the connecting column.

Specifically, the body 222 is hexahedron shaped, and the connecting part 223 is a connecting block integrally formed on the main body 222. The connecting block is located in the center of the front side of the main body 222. The side wall of the main body 222 close to the input gear 10 is the second tooth surface 221, and the side wall of the connecting block close to the input gear 10 extends to flush with the second tooth surface 221, the second tooth surface 221 extends to the side wall of the connecting block close to the input gear 10, i.e., the side wall of the connecting block close to the input gear 10 is also provided with the teeth which is the same as the teeth on the second tooth surface 221 and is configured to be engaged with the input gear 10. Correspondingly, the first connecting groove 224 though the main body 222 comprises two opposite side walls. Thus, when the connecting block 224 extends into the first connecting groove, the teeth on the connecting block just fill the vacancy of the teeth caused by the first connecting groove 224, such that the teeth on the back rack unit 22 can blend with the teeth of front rack unit 22. Similarly, the above-described structure allows the rack unit 22 to have a more compact structure and have a better blend when the rack unit 22 is connected with the plunger 21.

And the two opposite side walls 224 of the first connecting groove are provided with two first connecting holes 225, the connecting block provided with a second connecting hole 226, when the connecting block is inserted into the first connecting groove 224, the second connecting hole 226 aligns with the two first connecting holes 225, the connecting column is in turn inserted through the three connecting holes thereby achieving the connection of adjacent rack units 22. In this embodiment, the connecting column is a pin. The connection structure between the rack unit 22 and the plunger 21 is the same as the connection structure between adjacent rack units 22, also the connection is achieved through the pin. The pin is parallel to the second tooth surface 221 and the first tooth surface 211, i.e., as shown in FIG. 2, the pin is arranged vertically. Thus, each of the rack units 22 may rotate inwardly or outwardly about the pin.

In this embodiment, the connected rack units 22 form a corner, the corner has a center, each rack unit 22 rotates about the center, each connecting column i.e. the pin is disposed on the arc trajectory of the corner.

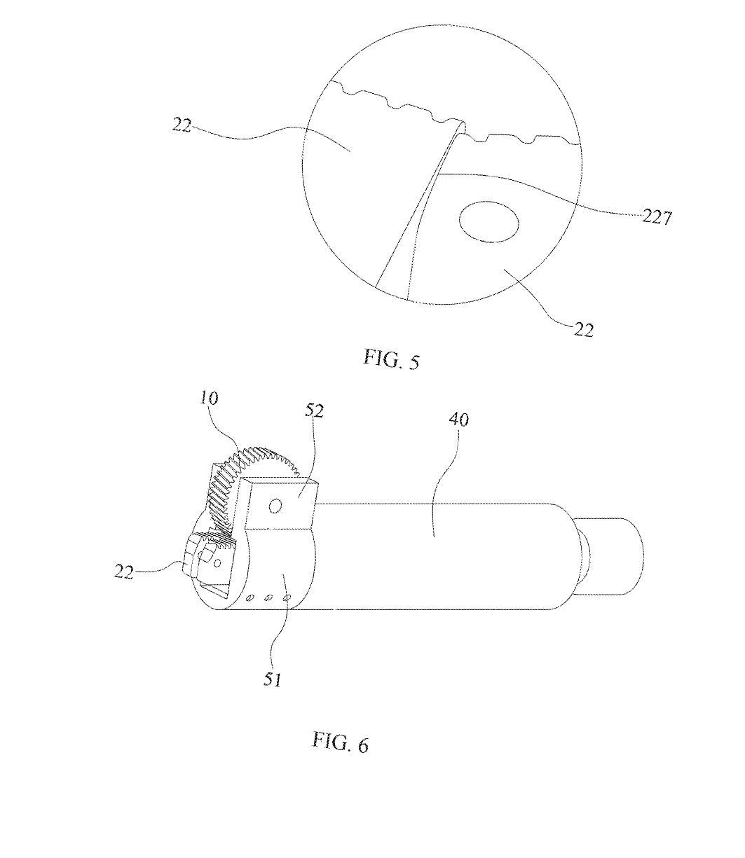

The rear wall of the main body 222 of each rack unit 22 is provided with a first inclined surface 227 at the position connected with the second tooth surface 221. In conjunction with FIG. 3 and FIG. 5, during the motion of the rack unit 22, the inner side of the front side of the back rack unit 22 contacts the inner side of the back side of the front rack unit 22, the provided first inclined surface 227 at this position can not only to avoid the adjacent two rack units 22 from interfering each other at the contact position, but also can be used to control the angle between two adjacent rack units 22 before the corner, such that the rack unit 22 can be moved along the arc trajectory of the corner.

Also, to avoid the interference and to control the angle, in the first connecting groove 224, an inner wall opposite to a insertion direction of the connecting part 223 is provided with a second inclined surface 228 at the position connected with the second tooth surface 221; within the second connecting groove 212, the inner wall opposite to the insertion direction of the connecting part 223 is provided with a third inclined surface (not shown) at the position connected with the first tooth surface 211.

Preferably, in this embodiment, the teeth on the first tooth surface 211 and the teeth on the second tooth 221 are helical teeth; correspondingly the input gear 10 is the helical gear. The input gear 10 may be engaged with the plunger 21 and each rack unit 22 through the helical teeth, the contact ratio is high, such that a greater torque transmission can be achieved. Of course, the first tooth surface 211 and the second tooth surface 221 may be set to be straight tooth surfaces.

Conjunction with FIG. 1 and FIG. 6, in this embodiment, the rack corner steering mechanism further comprises a housing 30, a cylinder 40 and a retainer 50. The housing 30 has a right angle corner, the cylinder 40 is arranged in front of the corner, that is, the cylinder is located on one side of the corner. The plunger 21 is inserted into the cylinder, each rack unit 22 is located at the corner, the input gear 10 is fixed on the retainer 50. Of course, the corner may be a non-right angle corner, in this embodiment, in the rack corner steering mechanism, the angle of the corner is not limited.

The retainer 50 comprises a nozzle portion 51 with a C-shaped cross-section and fixing portions 52 extending upward from two ends of the nozzle portion 51, the nozzle portion 51 is connected to the cylinder 51 to allow the plunger 21 and each rack unit 22 to pass through, the input gear 10 is fixed between two fixing portion 52. The above components are fixed through the above configuration, such that the overall structure of the steering mechanism is compact, that space of the corner is made full use to place the rack units, to achieve long-distance linear motion of the plunger 21.

In this embodiment, the bottom of the nozzle portion 51 is provided with needle rollers 60, the needle rollers 60 allow combining the rotation and the roll, thereby reducing the frictions between the plunger 21 and the retainer 50 and between the rack unit 22 and the retainer 50 during motion, which helps to improve transmission efficiency, reduce noise and reduce the impact.

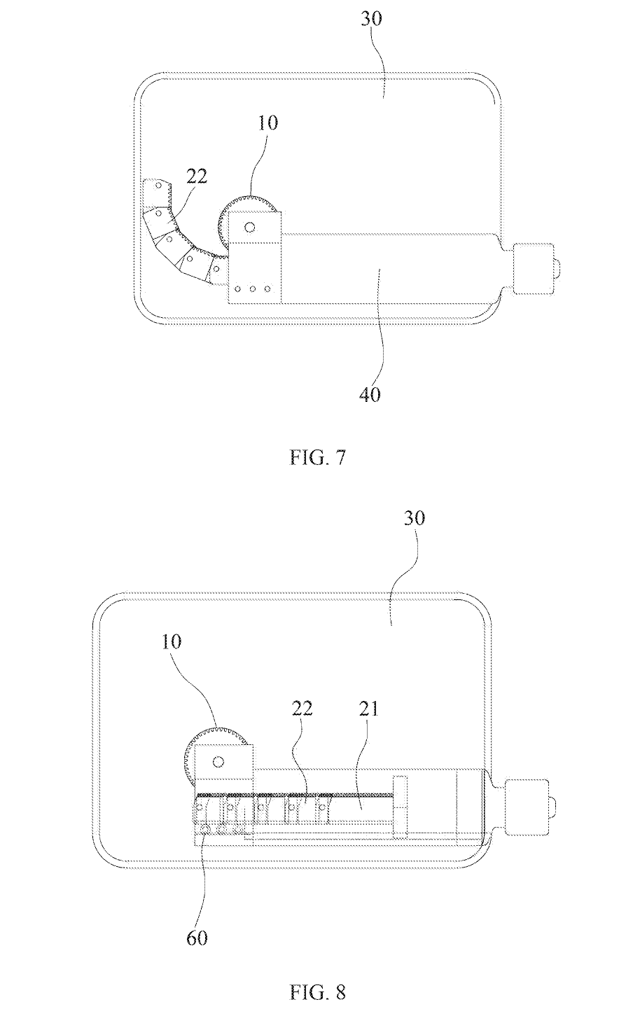

Referring to FIGS. 7 and 8, the input gear 10 is rotated to drive the plunger 21 to move forward and enter the cylinder 40, and then moves straightly along the cylinder 40. The plunger 21 is moved forward also leads the plurality of rack units 22 connected with the plunger 22 to move forward along the corner. As shown in FIG. 7, at the beginning of the motion, the adjacent rack units 22 are obliquely connected, when the rack unit 22 is engaged with the input gear 10, the rack unit 22 is rotated is in line with the plunger 21.

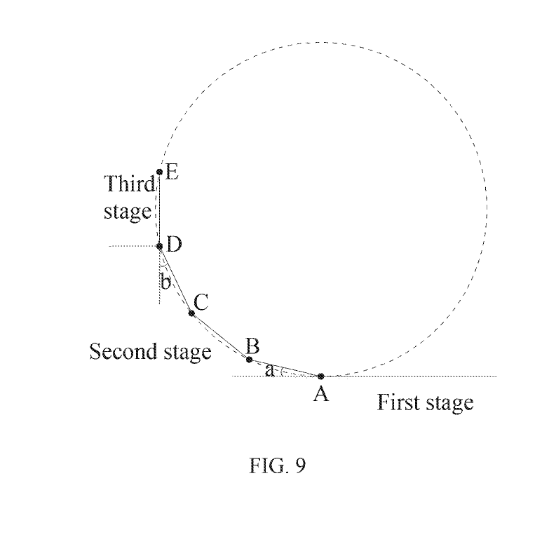

Referring to FIG. 9, when the rack unit 22 is moved forward at the corner, when the input gear 10 drives the plunger 21 to move forward, the connection point A of the plunder 21 and the adjacent rack unit 22 moves along a horizontal line, that is a first stage, in this case the angle “a” between the rack unit 22 and the horizontal direction is gradually reduced to zero; when each of the other rack units 22 is moved forward, the distances between the connection points B, C, D between the rack units 22 maintain the fixed length of the rack cell 22, and the connection points B, C, D are located on a circle (as shown by a broken line) and rotate about the center of the circle, that is the second phase, the angle between the rack units 22 doesn't change; the connection point E of the last rack unit 22 is moved along the vertical direction before entering the arc region of the corner, that is the first stage, the angle “b” between the rack unit 22 between point C and point D and the vertical direction increases gradually from 0, when entering the arc of the corner i.e. entering the second stage, the angle “b” reaches a maximum, the maximum value of the angle “b” is equal to the value of the angle of the first inclined surface 227 of the rack unit 22. When the input gear 10 drives inversely, the principle is the same as that of the above motion, only the direction is opposite.

The present invention also provides a transmission device (not shown), the transmission device comprises the rack corner steering mechanism mentioned above. The rack corner steering mechanism allow the flexible steering in the steering mechanism, and has the advantages of smooth operation, good continuity, low noise, high bearing capacity, reliable, compact structure, and small volume.

The foregoing descriptions are merely exemplary embodiment of the present invention, but are not intended to limit the present invention to it. Any modification, equivalent replacement, or improvement made without departing from the spirit and principle of the present invention shall fall within the protection scope of the present invention.

What is claimed is:

1. A rack corner steering mechanism comprising an input gear and a rack steering assembly driven by the input gear, wherein the rack steering assembly comprises a plunger and a plurality of rack units which are successively movably connected to an end of the plunger and arranged in a corner shape, wherein the plunger is a straight bar and is moved along a straight trajectory, a side wall of the plunger close to the input gear is a first tooth surface to be engage with the input gear, the side walls of each of the rack units close to the input gear is a second tooth surface to be engage with the input gear, the rack unit adjacent to the plunger is obliquely connected to the end of the plunger, each of the other rack units is successively connected to the end of the front rack unit, and when the second tooth surface of the rack unit is engage with the input gear, the rack unit is rotated and is in line with the plunger.

2. The rack corner steering mechanism of claim 1, wherein each of the rack unit comprises a main body, the front side of the main body is provided with a connecting part, the rear side of the main body is caved inward to form a first connecting groove, the end of the plunger is provided with a second connecting groove, the connecting part of the rack unit adjacent to the plunger extends in the second connecting groove and is pivotally connected through a connecting column, the connecting part of each of the other rack unit successively extend in the first connecting groove of the front rack unit and is pivotally connected through the connecting column.

3. The rack corner steering mechanism of claim 2, wherein each connecting part is a connecting block integrally formed on the main body, the side walls of the main body close to the input gear is the second tooth surface, the side wall of the connecting block close to the input gear flushes with the second tooth surface, the second tooth surface extends to the side wall of the connecting block close to the input gear, and the connecting column is parallel to the second tooth surface.

4. The rack corner steering mechanism of claim 2, wherein each connecting column is disposed on an arc trajectory of the corner.

5. The rack corner steering mechanism of claim 2, wherein the rear wall of each main body is provided with a first inclined surface at the position connected with the second tooth surface.

6. The rack corner steering mechanism of claim 2, wherein within the first connecting groove, an inner wall opposite to a insertion direction of the connecting part is provided with a second inclined surface at the position connected with the second tooth surface; within the second connecting groove, the inner wall opposite to the insertion direction of the connecting part is provided with a third inclined surface at the position connected with the first tooth surface.

7. The rack corner steering mechanism of any of claims 1-6, wherein the rack corner steering mechanism further comprises a housing, a cylinder and a retainer, the housing has the corner, the cylinder is arranged at the front side of the corner, the plunger is inserted into the cylinder, each rack unit is located at the corner, the input gear is fixed on the retainer.

8. The rack corner steering mechanism of claim 7, wherein the retainer comprises a nozzle portion with a C-shaped cross-section and fixing portions extending upward from two ends of the nozzle portion, the nozzle portion is connected to the cylinder to allow the plunger and each rack unit to pass through, the input gear is fixed between two fixing portions.

9. The rack corner steering mechanism of claim 8, wherein the bottom of the nozzle portion is provided with needle rollers.

10. A transmission device comprising the rack corner steering mechanism of any of claims 1-9.
